(19) United States
(12) Patent Application Publication
(10) Pub. No.: US 2026/0309185 A1
(43) Pub. Date: Oct. 8, 2026

(54) BEARING DEVICE WITH INTEGRATED ELECTRICAL INSULATION, IN PARTICULAR FOR AN ELECTRIC MOTOR OR MACHINE

(71) Applicant: AKTIEBOLAGET SKF, GOTEBORG (SE)

(72) Inventors: Mickael CHOLLET, Joué-Lès-Tours (FR); Bruno CONSTANT, Tours (FR); Benoit ARNAULT, Saint-Cyr-sur-Loire (FR); Jean-Marie GERARD, Joué-Lès-Tours (FR); Kevin WATTIEAUX, Pernay (FR)

(21) Appl. No.: 19/577,829

(22) Filed: Mar. 25, 2026

(30) Foreign Application Priority Data
Apr. 3, 2025 (FR) FR2503495

(51) Int. Cl. F16C 19/06; F16C 33/08

(52) U.S. Cl. CPC F16C 19/06; F16C 33/08; F16C 2202/30; F16C 2380/26

(57) ABSTRACT

A bearing device includes a bearing having first and second rings, a bushing, and an electrically insulating insert over-molded between and connecting the bushing and the second ring. The bushing is axially split into a first part and a second part having mutually facing front faces, and at least one of the front faces has at least one notch. The insert is over-molded onto the front faces and onto lateral walls of the at least one notch.

### CROSS-REFERENCE

This application claims priority to French patent application no. FR2503495 filed on Apr. 3, 2025, the contents of which are fully incorporated herein by reference.

### TECHNOLOGICAL FIELD

The present disclosure relates to the field of bearings which are used, in particular, in electric motors, electric machines and associated equipment.

### BACKGROUND

In an electric motor or machine having a casing and a rotatable shaft, at least one rolling bearing is mounted between the casing and the shaft in order to rotatably support this shaft. During operation, when the shaft is in rotation, a difference in electrical potential can occur between the shaft and the casing of the electric motor or machine, which generates an electrical current between the inner ring of the rolling bearing which is fixed to the shaft and the outer ring which is fixed to the casing. The electrical current passing through the components of the rolling bearing can damage these components, in particular the rolling elements and the raceways formed on the inner and outer rings. The electrical discharges can also generate vibrations.

In order to remedy these drawbacks, it is known to replace the rolling elements of the bearing, which are produced from the same steel as that of the inner and outer rings with ceramic rolling elements. Generally this is referred to as a hybrid rolling bearing. However, such a hybrid rolling bearing is relatively costly.

In order to remedy the aforementioned drawbacks, it is also known to provide the outer ring of the rolling bearing with an insulating sleeve which is provided with a bushing and with an insulating liner which is produced from electrically insulating material and which is interposed radially between the outer ring and the bushing, the insulating liner being overmolded onto the outer ring and onto the bushing. However, occasionally, the adhesion between the insulating liner and the bushing is insufficient in order to immobilize them relative to one another.

### SUMMARY

The present disclosure thus aims to remedy this drawback by providing a bearing device of simple and economic design.

The disclosure relates to a bearing device comprising a bearing having a first ring and a second ring which are configured to rotate relative to one another and an insulating sleeve which is mounted on the second ring of the bearing and which includes a bushing and an insulating liner which is interposed radially between the second ring and the bushing and which is produced from electrically insulating material, the insulating liner being overmolded onto the second ring of the bearing and onto the bushing.

According to a general feature, the bushing is produced in at least two separate parts, each comprising at least one axial portion which is provided with a front face, the front faces of the axial portions of the parts being at least locally spaced apart axially from one another. According to a further general feature, at least one of the axial portions of the parts comprises at least one notch which extends at least partially axially from the front face of the axial portion and which is delimited in the circumferential direction by two opposing lateral walls.

According to a further general feature, the insulating liner is overmolded at least onto one of the inner and outer surfaces of the axial portions of the parts, oriented radially on the side of the second ring of the bearing, onto the front faces of the axial portions and onto the lateral walls of the notch. Thus, the material of the insulating liner received in the notch opposes the relative circumferential movement of the part of the bushing provided with the notch and the insulating liner by bearing against the lateral walls. In other words, the rotation of the part of the bushing provided with the notch and the insulating liner relative to one another is hindered in the two directions. Preferably, at least one of the axial portions of the parts of the bushing comprises a plurality of so-called notches distributed regularly in the circumferential direction. Advantageously, the notches are identical to one another.

According to a further feature, the axial portions each comprise at least one so-called notch, the notches being symmetrical to one another relative to a radial median plane of the bearing device.

According to a further feature, the axial portions each comprise at least one so-called notch, the notches of an axial portion each receiving a region of the other axial portion of complementary shape to the notch receiving the region.

According to a further feature, the at least one notch is axially delimited by a bottom wall connecting the lateral walls and defining a semi-rectangular contour with the lateral walls.

According to a further feature, the at least one notch is axially delimited by a bottom wall connecting the lateral walls and defining a semi-circular contour with the lateral walls.

According to a further feature, at least one of the lateral walls is oriented, at least locally, axially opposing the front face.

In other words, by bearing against the lateral wall, the material of the insulating liner received in the notch also opposes the relative movement of the bushing and the insulating liner in the axial direction toward the outside, i.e. prevents the separation of one relative to the other.

For example, the at least one notch is axially delimited by a bottom wall connecting the lateral walls and defining a dovetailed contour with the lateral walls.

According to a further feature, at least one of the parts of the bushing has the shape of an open ring delimited in the circumferential direction by the opposing lateral walls.

### BRIEF DESCRIPTION OF THE DRAWINGS

The present disclosure will be understood more clearly by studying the detailed description of embodiments provided by way of non-limiting examples and illustrated by the accompanying drawings, in which:

FIG. 1 is a perspective view of a bearing device according to a first exemplary embodiment of the disclosure.

FIG. 2 is a side elevational view of the bearing device of FIG. 1.

FIG. 3 is sectional view of the bearing device of FIG. 1 taken in the direction of line III-III of FIG. 2.

FIG. 4 is sectional view of the bearing device of FIG. 1 taken in the direction of line IV-IV of FIG. 2.

FIG. 51 is a perspective view of a bearing device according to a second exemplary embodiment of the disclosure.

FIG. 6 is a side elevational view of a bearing device according to a third exemplary embodiment of the disclosure.

FIG. 7 is a side elevational view of a bearing device according to a fourth exemplary embodiment of the disclosure.

FIG. 8 is a side elevational view of a bearing device according to a fifth exemplary embodiment of the disclosure.

FIG. 9 is a side elevational view of a bearing device according to a sixth exemplary embodiment of the disclosure.

FIG. 10 is a perspective view of a portion of bearing device of FIG. 6.

### DETAILED DESCRIPTION

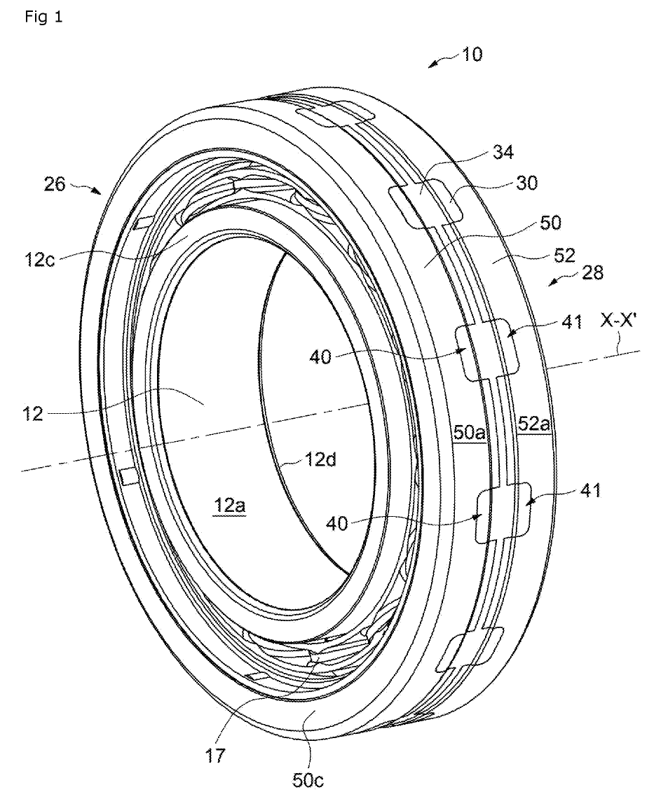

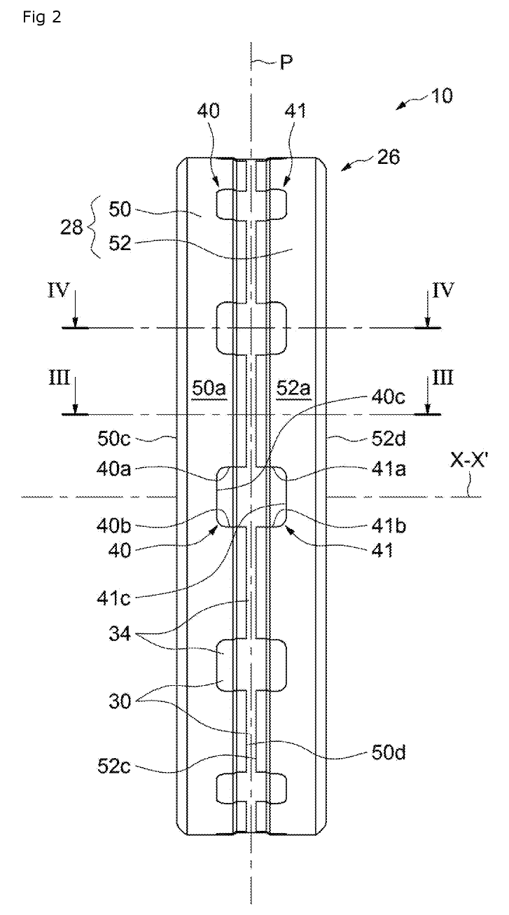

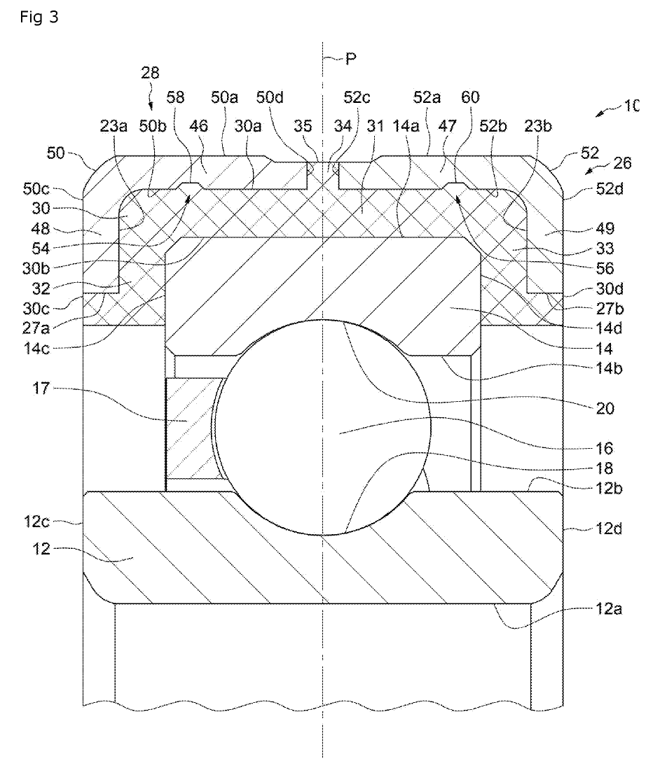

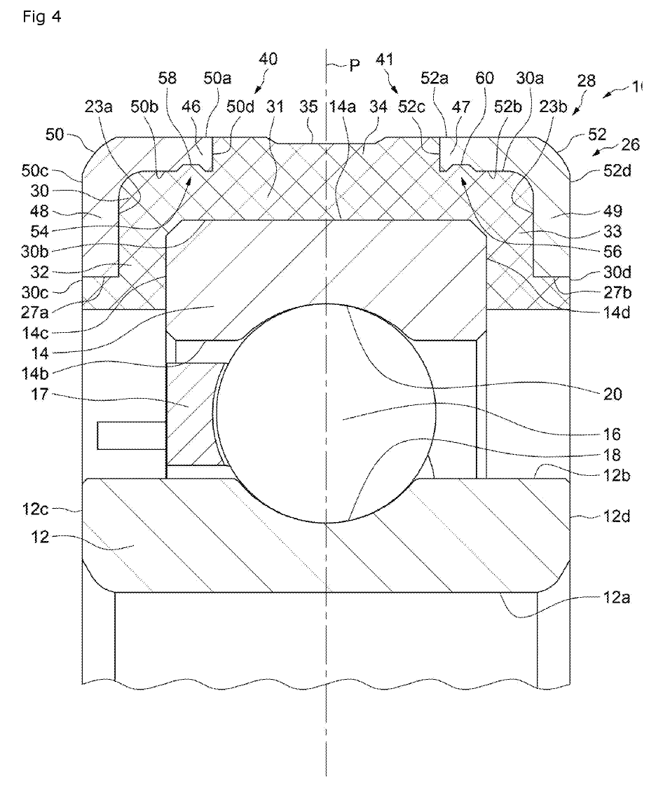

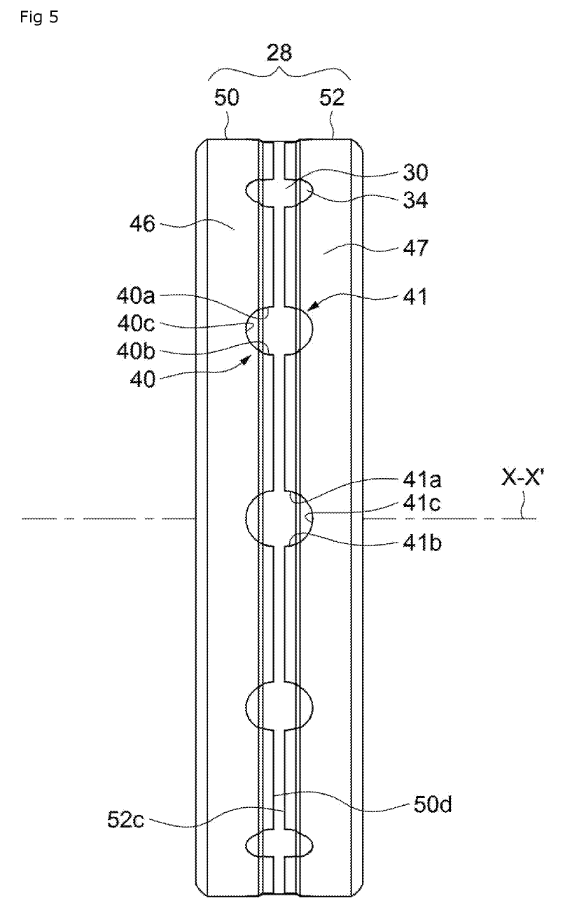

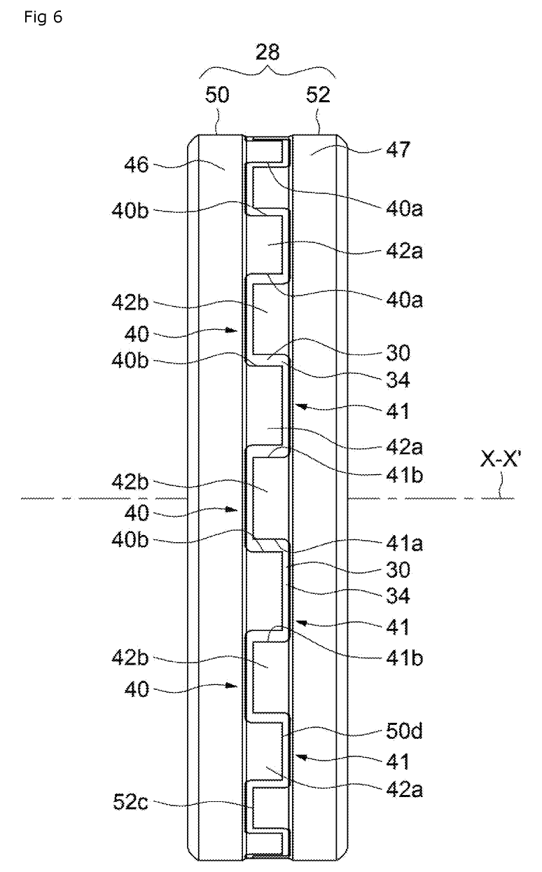

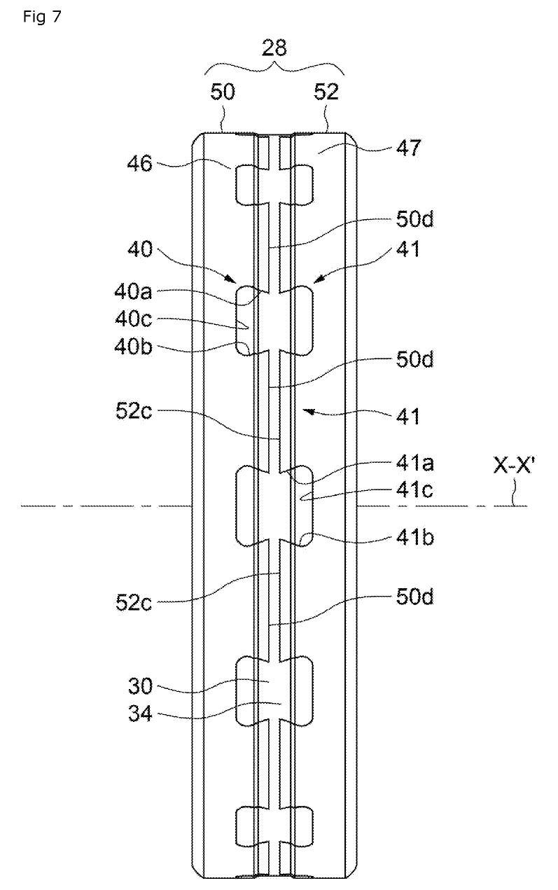

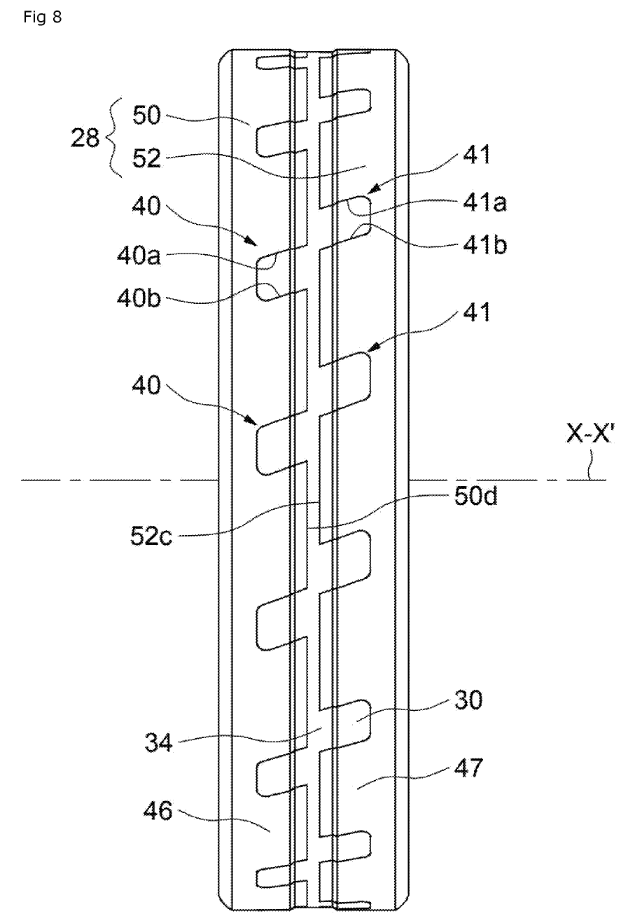

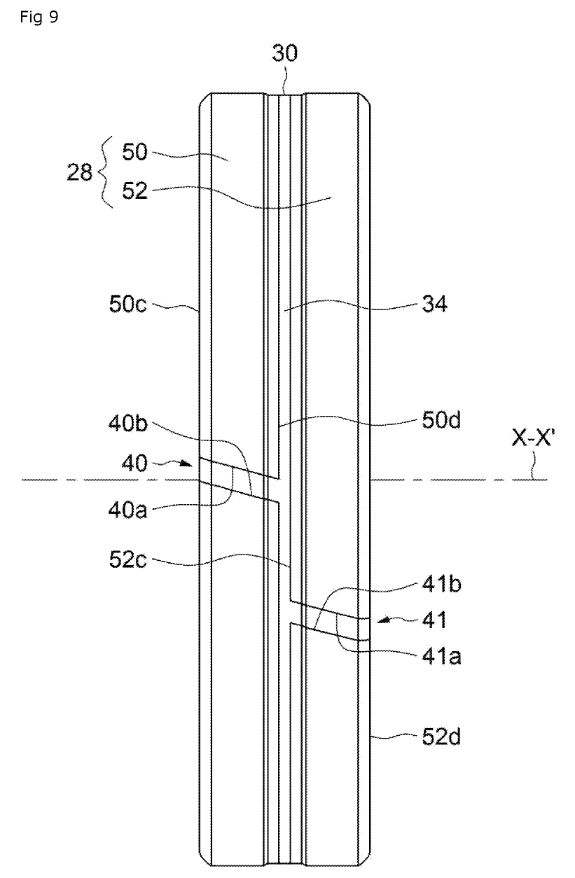

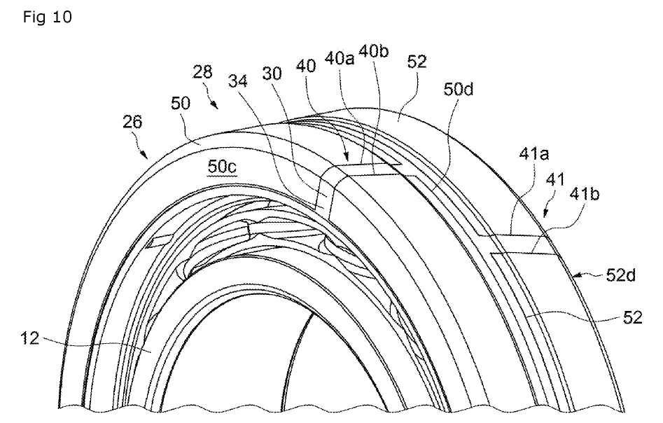

The bearing device illustrated in FIGS. 1 to 4 comprises a bearing 10 which has a first ring 12 and a second ring 14 which are configured to rotate relative to one another about the axis X-X' of the bearing. In the illustrated exemplary embodiment, the first ring 12 is the inner ring of the bearing and the second ring 14 is the outer ring.

The bearing device is designed so as not to conduct electrical currents. The bearing device has integrated electrical insulation.

The inner 12 and outer 14 rings of the bearing 10 are concentric and extend axially along the axis X-X' of the bearing. The inner 12 and outer 14 rings are produced from steel. The rings are of the solid type.

In the illustrated exemplary embodiment, the bearing 10 also comprises a row of rolling elements 16, in this case balls, interposed radially between the inner 12 and outer 14 rings. The rolling elements 16 are produced from steel. The bearing 10 also comprises a cage 17 for maintaining the regular circumferential spacing of the rolling elements 16.

In the illustrated exemplary embodiment, the bearing of the system has a single row of rolling elements 16. In a variant, the bearing may have a plurality of rows of rolling elements. Moreover, the rolling bearing can comprise different types of rolling elements from balls, for example rollers. In a further variant, the bearing can be a plain bearing without rolling elements.

The inner ring 12 comprises an axially extending cylindrical inner bore 12a, a cylindrical axial outer surface 12b radially opposing the inner bore 12a, and radially opposing first and second front faces 12c, 12d axially delimiting the inner bore 12a and the outer surface 12b. The inner bore 12a and the outer surface 12b delimit the radial thickness of the inner ring 12. The inner bore 12a forms the inner surface of the inner ring. The first and second front faces 12c, 12d delimit the axial length of the inner ring 12. The inner ring 12 also includes an inner raceway 18 for the rolling elements 16 which is formed on the outer surface 12b. The raceway 18 is oriented radially outward.

The outer ring 14 has a cylindrical axially extending outer surface 14a, a cylindrical inner bore 14b radially opposing the outer surface 14a and first and second opposing radial front faces 14c, 14d axially delimiting the inner bore 14b and the outer surface 14a. The outer surface 14a and the inner bore 14b delimit the radial thickness of the outer ring 14. The first and second faces 14c, 14d delimit the axial length of the outer ring 14. The front face 14c of the outer ring 14 is offset axially inward relative to the front face 12c of the inner ring 12. The front face 14d of the outer ring is offset axially inward relative to the front face 12d of the inner ring 12. The outer ring 14 also has an outer raceway 20 for the rolling elements 16 which is formed on the bore 14b. The raceway 20 is oriented radially toward the inside.

The bearing device also comprises an electrical insulating sleeve 26 which is mounted on the outer ring 14. The insulating sleeve 26 is mounted on the outer surface 14a of the outer ring 14.

The insulating sleeve 26 includes a bushing 28 and an insulating liner 30 which is interposed radially between the outer ring 14 and the bushing 28. The insulating liner 30 is over-molded in this case onto the outer ring 14 and onto the bushing 28. The insulating sleeve 26 is fixed to the outer ring 14, in particular due to the adhesion between the insulating liner 30 and the outer ring 14.

The bushing 28 has a first part 50 and a second part 52 which are separate. These two separate parts 50, 52 form half-flanges. The two parts 50, 52 are axially spaced apart from one another. Preferably, the parts 50, 52 of the bushing 28 are formed from steel. The parts 50, 52 can advantageously be obtained from a sheet metal blank by cutting, stamping and rolling. As a variant, the parts 50, 52 can be obtained from a tube or from forged and/or rolled blanks, or even from deep drawing.

In the first exemplary embodiment illustrated in FIGS. 1 to 4, the parts 50, 52 of the bushing 28 are identical and symmetrical relative to the radial median plane P of the system. Each part 50, 52 is annular. Each part 50, 52 comprises a cylindrical axial outer surface 50a, 52a and a cylindrical axial bore 50b, 52b radially opposing the outer surface 50a, 52a. The outer surface 50a, 52a and the bore 50b, 52b delimit the radial thickness of each part 50, 52. The bore 50b, 52b forms the inner surface of the part 50, 52, the inner surface being oriented radially on the side of the inner ring 12. The bore 50b, 52b is oriented radially toward the inside, i.e. on the side of the outer ring 14 and the insulating liner 30. The axis 25 of the bore 50b, 52b is coaxial with the axis X-X'.

The part 50 also has first and second radially opposing front faces 50c, 50d axially delimiting the bore 50b and the outer surface 50a. The front faces 50c, 50d delimit the axial length of the part 50.

The part 52 also comprises first and second radially opposing front faces 52a, 52d axially delimiting the bore 52b and the outer surface 52a. The front faces 52c, 52d delimit the axial length of the part 52. The front faces 50c, 52d delimit the axial dimension of the insulating sleeve 26, i.e. the axial length of the bearing device. The front faces 50d, 52c are axially spaced apart from one another, in this case continuously over the entire circumference of the part 50, 52 of the bushing 28.

The front faces 14c, 50c of the outer ring 14 and the part 50 are located axially on a first side relative to a radial median plane P of the system, and the front faces 14d, 52d of the outer ring 14 and the part 52 are located axially on a second side relative to the radial median plane P which opposes the first side. The radial median plane P passes in this case through the center of the rolling elements 16.

The front face 14c of the outer ring 14 is offset axially inward relative to the front face 50c of the part 50. The front face 14d of the outer ring 14 is offset axially inward relative to the front face 52d of the part 52. In other words, the front faces 14c, 14d of the outer ring 14 are axially set back relative to the front faces 50c, 52d of the parts 50, 52. In other words, the axial dimension of the outer ring 14 is less than the axial dimension of the insulating sleeve 26.

In the illustrated exemplary embodiment, the front faces 12c, 50c and 12d, 52d of the inner ring 12 and the parts 50, 52 are respectively coplanar. Alternatively, it is possible to provide different arrangements. For example, the parts 50, 52 could extend so as to protrude axially relative to the faces 12c and 12d of the inner ring or remain axially set back from these faces.

Each part 50, 52 of the bushing comprises an annular axial portion 46, 47 and an annular radial collar 48, 49 extending radially toward the inside the axial portion 46, 47. Each part 50, 52 has an L-shaped section, the limbs thereof being respectively formed by the axial portion 46, 47 and the radial collar 48, 49.

The radial collar 48, 49 extends the end of the axial portion 46, 47, which is located axially on the outer side of the system, as far as a free end 27a, 27b of the radial collar 48, 49. In the illustrated exemplary embodiment, the radial collars 48, 49 are continuously annular. Alternatively, at least one of the radial collars 48, 49 could be in the form of regions spaced apart from one another in the circumferential direction.

In the illustrated exemplary embodiment, the radial collars 48, 49 extend radially beyond the outer surface 14a of the outer ring, i.e. radially protruding toward the inside relative to the outer surface 14a. In other words, on each radial collar 48, 49, the bore 50b, 52b radially protrudes toward the inside relative to the outer surface 14a. Each radial collar 48, 49 is delimited on the outer side by the front face 50c, 52d which forms its outer face.

Each radial collar 48, 49 has an inner face 23a, 23b axially opposing the front face 50c, 52d. The inner face 23a, 23b of the collar 48, 49 and the front face 50c, 52d axially opposing the inner face delimit the axial thickness of the collar 48, 49. For each collar 48 and 49, the inner face 23a, 23b is oriented axially toward the inside of the system, and the front face 50c, 52d, which forms its outer face, is oriented axially toward the outside of the system. The free end 27a, 27b of each radial collar 48, 49 connects the inner face 23a, 23b to the front face 50c, 52d which forms its outer face.

The axial portion 46, 47 extends axially toward the inside the end of the radial collar 48, 49 located radially on the outer side of the system. The axial portion 46, 47 is delimited on the inner side by the front face 50d, 52c. In the first illustrated exemplary embodiment, the axial portions 46, 47 are continuously annular.

On each axial portion 46, 47, the bore 50b, 52b is radially set back toward the outside relative to the outer surface 14a. The bores 50b, 52b of the axial portions 46, 47 of the parts 50, 52 each have a groove 54, 56 which extends in the circumferential direction about the axis 25 of the corresponding bore 50b, 52b. Each groove 54, 56 is oriented radially on the side of the outer ring 14, i.e. radially toward the inside. In the illustrated exemplary embodiment, each groove 54, 56 is annular. Alternatively, it could be possible that at least one of the two grooves 54, 56 does not extend over 360º.

Each groove 54, 56 is delimited in the axial direction by two opposing lateral flanks which have a rectangular profile in axial section and which are connected to one another by an axial base. Alternatively, it is possible to provide other shapes, for example grooves having in cross section a circular-arc shape oriented toward the inside.

The insulating liner 30 is made from electrically insulating material. The insulating liner 30 can be produced, for example, from synthetic material, such as a PEEK or a PA46, or even be produced from elastomer material, for example from rubber. Advantageously, the insulating liner 30 is produced from flexible electrically insulating material. The insulating liner 30 is annular.

The insulating liner 30 comprises a cylindrical axially extending outer surface 30a, a cylindrical bore 30b radially opposing the outer surface 30a and first and second radially extending opposing front faces 30c, 30d axially delimiting the bore 30b and the outer surface 30a. The front radial faces 30c, 30d axially delimit the insulating liner 30. The outer surface 30a and the bore 30b delimit the radial thickness of the insulating liner 30.

The outer surface 30a is in radial contact with the bores 50b, 52b of the parts 50, 52. In other words, the insulating liner 30 covers the bores 50b, 52b. The bore 30b is in radial contact with the outer surface 14a and with the front faces 14c, 14d of the outer ring. The bore 30b has a stepped shape.

The front face 30c of the insulating liner is offset axially toward the outside relative to the front face 14c of the outer ring. The front face 30d of the insulating liner is offset axially toward the outside relative to the front face 14d of the outer ring. In the illustrated exemplary embodiment, the faces 30c, 50c and 30d, 52d of the insulating liner 30 and the part 50, 52 are respectively substantially coplanar. Alternatively, it is possible to provide different arrangements. For example, the parts 50, 52 could extend so as to protrude axially from the insulating liner 30 relative to the faces 30c and 30d or remain axially set back from these faces.

The insulating liner 30 covers the inner face 23a, 23b of each collar 48, 49. The insulating liner 30 also covers the free end 27a, 27b of each collar 48, 49. The insulating liner 30 comprises an axial part 31, two radial end parts 32 and 33 each extending one of the axially opposing ends of the axial part 31 radially toward the inside, and an intermediate radial part 34 protruding from the side of the axial part 31 facing opposite the inner 12 and outer 14 rings. The radial part 34 thus protrudes radially toward the outside from the axial part 31.

The axial part 31 is interposed radially between the outer surface 14a of the outer ring 14 and the bores 50b, 52b of the parts 50, 52. The axial part 31 covers the outer surface 14a of the outer ring. The axial part 31 covers entirely the outer surface 14a of the outer ring, considering the axial and circumferential directions. The axial part 31 covers the bores 50b, 52b of the parts 50, 52. The axial part 31 also covers entirely the bores 50b, 52b, considering the axial and circumferential directions.

The axial part 31 comprises two ribs 58, 60 extending radially outward from the outer surface 30a and each housed inside a corresponding groove 54, 56 of the parts 50, 52. The rib 58, 60 is of complementary shape to the corresponding groove 54, 56. Each rib 58, 60 extends so as to protrude relative to the outer surface 30a of the insulating liner. Each rib 58, 60 is formed on the outer surface 30a during the over-molding of the insulating liner 30.

The radial part 32 is partially axially interposed between the radial collar 48 and the front face 14c of the outer ring 14. The radial part 33 is partially axially interposed between the radial collar 49 and the front face 14d of the outer ring 14. The radial parts 32, 33 partially cover the front faces 14c, 14d of the outer ring.

The radial part 34 is axially interposed between the front faces 50d, 52c of the parts 50, 52. The radial part 34 at least locally covers the front faces 50d, 52c of the parts 50, 52. In the first illustrated exemplary embodiment, the radial part 34 entirely covers the front faces 50d, 52c. The radial part 34 has a free end 35 radially opposing the axial part 31. The radial part 34 advantageously extends continuously in the circumferential direction, i.e. is annular. As a variant, however, the radial part could have interruptions, for example in a variant in which the front faces 50d, 52c of the parts 50, 52 would bear locally against one another.

The axial portions 46, 47 of the parts 50, 52 of the bushing and the radial part 34 of the insulating liner 30 jointly delimit the outer surface of the bearing device. The outer surfaces 50a, 52a of the parts 50, 52 of the bushing and the free end 35 of the radial part 34 of the insulating liner 30 jointly form the outer surface of the bearing device 10, in other words defining the outer diameter of the bearing device 10.

As will be described hereinafter, the radial part 34 of the insulating liner 30 and the axial portions 46, 47 of the parts 50, 52 of the bushing are configured to improve the fixing of each of the parts 50, 52 relative to the insulating liner 30 in the circumferential direction in the two directions.

The axial portions 46, 47 each comprise respectively a plurality of notches 40, 41 which each extend axially from the front face 50d, 52c. Each notch 40, 41 is delimited in the circumferential direction by two respectively opposing lateral walls 40a, 40b and 41a, 41b. Each notch 40, 41 is delimited in the axial direction by a bottom wall 40c, 41c, respectively connecting the lateral walls 40a, 40b and 41a, 41b. The lateral walls 40a, 40b and 41a, 41b are oriented in the axial direction. The bottom walls 40c, 41c are oriented in the radial plane.

The lateral walls 40a, 40b with the bottom wall 40c and the lateral walls 41a, 41b with the bottom wall 41c define the contour of the notch 40, 41. This contour is semi-rectangular. The notches 40, 41 are distributed regularly in the circumferential direction. The notches 40 are identical to one another. The notches 41 are identical to one another. The notches 40, 41 are also arranged in a mirror image of the notches 41, 40. More specifically, each notch 40, 41 is symmetrical to a corresponding notch 41, 40 relative to the radial median plane P of the bearing device 10.

Each notch 40, 41 is filled with the material of the insulating liner 30. More specifically, the radial part 34 of the insulating liner 30 extends axially in each of the notches 40, 41. Thus the insulating liner 30 is over-molded onto the lateral walls 40a, 40b and 41a, 41b. The insulating liner 30 is also over-molded onto the bottom walls 40c, 41c. The material of the insulating liner received in the notch 40, 41, by bearing against the lateral walls 40a, 40b and 41a, 41b, opposes the relative movement of the corresponding part 50, 52 of the bushing 28 and the insulating liner 30 in the circumferential direction. In other words, the rotation of the part 50, 52 and the insulating liner 30 relative to one another is hindered in the two directions.

To manufacture the bearing device, the method proceeds in the following manner. In a first step, the parts 50 and 52 of the bushing 28 and the outer ring 14 of the bearing are mounted inside a mold which is provided for over-molding the insulating liner 30. Then, in a second step, the insulating liner 30 is over-molded both onto the outer ring 14 and onto the bushing 28. Then, in a third successive step, the unitary assembly formed by the outer ring 14, by the parts 50 and 52 of the bushing 28 and by the insulating liner 30 is removed from the mold. Then, in a fourth step, the front faces 50c, 52d of the parts 50 and 52 of the bushing are ground. During this step, the outer surfaces 50a, 52a of the parts 50 and 52 of the bushing and the raceway 20 of the outer ring can also be ground. Finally, in a fifth step, the unitary assembly formed by the outer ring 14, the bushing 28 and the insulating liner 30 is assembled with the row of rolling elements 16, the cage 17 and the inner ring 12.

FIG. 5 illustrates a second exemplary embodiment of the disclosure which is identical to the first example, apart from that the contours of the notches 40, 41, respectively defined by the lateral walls 40a, 40b with the bottom wall 40c and by the lateral walls 41a, 41b with the bottom wall 41c, are semi-circular.

FIG. 6 illustrates a third exemplary embodiment of the disclosure in which the plurality of notches 40 and the plurality of notches 41 are nested in one another. More specifically, each notch 40, 41 of an axial portion 46, 47 receives a region 42b, 42a of the other axial portion 47, 46 having a complementary shape to the corresponding notch 40, 41. Each region 42a, 42b is delimited by two successive notches 40, 41. Each region 42a is delimited in the circumferential direction by the lateral wall 40a of a first notch 40 and by the lateral wall 40b of a second successive notch 40 of the first notch 40. Each region 42b is delimited in the circumferential direction by the lateral wall 41a of a first notch 41 and by the lateral wall 41b of a second successive notch 41 of the first notch 41. As a variant, there could be only one region 42a and/or 42b respectively delimited by the lateral walls 40a, 40b and/or 41a, 41b of one and the same notch 40 and/or 41.

As in the first example, the contour of the notches 40, 41 is semi-rectangular, providing the radial part 34 of the insulating liner 30 with a crenelated aspect. As a variant, this contour could be semi-circular, providing the radial part 34 of the insulating liner 30 with a serpentine aspect.

It will be noted that, in the first, second and third examples described above, the notches 40, 41 are configured to oppose exclusively the rotational movement of the parts 50, 52 relative to the insulating liner 30, i.e. the movement in the circumferential direction. More specifically each of the lateral walls 40a, 40b is oriented axially toward the other of the lateral walls 40b, 40a and/or exclusively toward the front face 50d, and each of the lateral walls 41a, 41b is oriented axially toward the other of the lateral walls 41a, 41b and/or exclusively toward the front face 52c.

FIGS. 7 to 9 respectively illustrate a fourth, fifth and sixth exemplary embodiment of the disclosure in which the notches 40, 41 are also configured to oppose an axial displacement in translation in the axial direction of the parts 50, 52 relative to the insulating liner 30. Thus, in these fourth, fifth and sixth exemplary embodiments, at least one of the lateral walls 40a, 40b is oriented at least locally axially opposing the front face 50d and/or at least one of the lateral walls 41a, 41b is oriented at least locally axially opposing the front face 52c.

In the fourth example illustrated in FIG. 7, the notches 40, 41 are similar to those of the first and second embodiments except that their contour is dovetailed. Each of the lateral walls 40a, 40b is oriented axially opposing the front face 50d. Each of the lateral walls 41a, 41b is oriented axially opposing the front face 52c. The lateral walls 40a, 40b and 41a, 41b in this example are entirely rotated toward the corresponding front face 50d, 52c, but in a variant this could apply to only one portion of at least one of these lateral walls 40a, 40b and 41a, 41b, the remainder of the lateral wall in question being oriented for example in the axial direction.

In the fifth example illustrated in FIG. 8, the notches 40, 41 are similar to those of the first example, except that their lateral walls 40a, 40b and 41a, 41b are inclined relative to the axial direction. The lateral walls 40b and 41a are respectively oriented axially opposing the front faces 50d and 52c. The lateral walls 40a and 41b are respectively oriented axially toward the front faces 50d and 52c. Moreover, the notches 40 and 41 are not substantially opposing but offset to one another in the circumferential direction.

In the sixth example illustrated in FIGS. 9 and 10, each axial portion 46, 47 is respectively provided with a single notch 40, 41. These notches 40, 41 are similar to those of the fifth example, except that they also each open respectively through the front face 50c and the front face 52d of the parts 50 and 52. Thus each part 50, 52 has the shape of an open ring respectively delimited in the circumferential direction by the lateral walls 40a, 40b and by the lateral walls 41a, 41b. As a variant, only one of the parts 50, 52 has the shape of an open ring.

In the illustrated examples, the two parts 50, 52 are provided with notches 40, 41, but in a variant only one of the parts 50, 52 could be provided with at least one such notch 40, 41. As a further variant, it is possible to provide non-symmetrical parts 50, 52, the bushing resulting, for example, from the association of the part 50 of the first example with the part 52 of the second embodiment.

In a further variant, it could be possible to provide that the bushing 28 consists of more than two parts, with for example an additional annular part between the parts 50 and 52, which additional part would be provided with notches such as 40, 41 over at least one of its axially opposing front faces and each overmolded by the insulating liner.

The notches 40, 41 are obtained, for example, by machining the axial portions 46, 47 of the parts 50, 52.

In the illustrated exemplary embodiments, the first ring 12 of the bearing is the inner ring and the second ring 14 on which the insulating liner 30 is overmolded is the outer ring.

Alternatively, it is possible to provide a reverse arrangement in which the second ring 14 to which the insulating liner 30 is fixed is the inner ring. In this case, the insulating sleeve is located in the bore of the inner ring. The insulating liner is thus interposed radially between the bore 12a of the inner ring and the outer surfaces respectively of the parts of the bushing and the insulating liner overmolding these outer surfaces, which outer surfaces are oriented radially on the side of the second ring 14. The insulating liner is fixed at least to the inner surface of the inner ring and at least to the outer surface of the parts of the bushing. In the insulating liner, the intermediate radial part then protrudes radially toward the inside from the axial part.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved electrically insulated bearing devices.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A bearing device comprising:
a bearing including a first ring and a second ring configured to rotate relative to each other about a central axis, the second ring having a first cylindrical surface and a second cylindrical surface radially spaced from the first cylindrical surface,
a bushing, and
an electrically insulating insert overmolded between and connecting the bushing and the second cylindrical surface of the second ring,
wherein the bushing comprises a first part having an axially extending first cylindrical portion and a first annular collar extending radially from a first axial end of the first cylindrical portion and a first front face at a second axial end of the first cylindrical portion, and a second part having an axially extending second cylindrical portion and a second annular collar extending radially from a first axial end of the second cylindrical portion and a second front face at a second axial end of the second cylindrical portion, the second front face facing and being spaced from the first front face,
wherein a first surface of the first cylindrical portion faces the second ring and a first surface of the second cylindrical portion faces the second ring and wherein a first surface of the first collar faces a first surface of the second collar,
wherein the electrically insulating insert is overmolded onto the first surface of the first cylindrical portion and onto the first surface of the second cylindrical portion and onto the first surface of the first collar and onto the first surface of the second collar,
wherein the first part includes at least one first notch extending axially into the first front face toward the first axial end of the first cylindrical portion, each of the at least one notch being delimited by a first lateral wall and a second lateral wall opposing the first lateral wall, and
wherein the electrically insulating insert is overmolded onto the first front face and the second front face and onto the first lateral wall and the second lateral wall of the at least one notch.

2. The bearing device according to claim 1,
wherein the at least one first notch comprises a plurality of equally circumferentially spaced first notches.

3. The bearing device according to claim 2,
wherein each of the plurality of first notches has a same shape.

4. The bearing device according to claim 2,
wherein the second part includes at least one second notch extending axially into the second front face toward the first axial end of the second cylindrical portion, the at least one second notch being delimited by a third lateral wall and a fourth lateral wall opposing the third lateral wall.

5. The bearing device according to claim 4,
wherein the first cylindrical portion is symmetrical to the second cylindrical portion relative to a radial median plane of the bearing device.

6. The bearing device according to claim 4,
wherein the at least one first notch comprises a plurality of equally circumferentially spaced first notches and the at least one second notch comprises a plurality of equally circumferentially spaced second notches, and
wherein the plurality of first notches are circumferentially offset from the plurality of second notches.

7. The bearing device according to claim 6,
wherein a part of the first cylindrical portion circumferentially between a first notch of the plurality of first notches and a second notch of the plurality of first notches projects into a first notch of the second plurality of notches.

8. The bearing device according to claim 4,
wherein the at least first one notch is axially delimited by a bottom wall connecting the first lateral wall to the second lateral wall, and
wherein the bottom wall extends circumferentially.

9. The bearing device according to claim 4,
wherein the at least first one notch is axially delimited by a bottom wall connecting the first lateral wall to the second lateral wall, and
wherein the bottom wall is curved.

10. The bearing device according to claim 4,
wherein the first and second lateral walls extend at an acute angle to the axial direction.

11. The bearing device according to claim 4,
wherein the at least one first notch is axially delimited by a bottom wall connecting the first and second lateral walls, and
wherein a circumferential length of the bottom wall is greater than a circumferential width of the first notch at the first front face of the first cylindrical portion.

12. The bearing device according to claim 4,
wherein the at least one first notch extends from the first front face through the first annular collar.
